(19) United States
(12) Patent Application Publication
(10) Pub. No.: US 2015/0216119 A1
(43) Pub. Date: Aug. 6, 2015

(54) TOOL HANDLE SYSTEM

(71) Applicant: Daniel J. Squires, Amherst, OH (US)

(72) Inventor: Daniel J. Squires, Amherst, OH (US)

(21) Appl. No.: 14/174,220

(22) Filed: Feb. 6, 2014

(51) Int. Cl. A01D 7/10

(52) U.S. Cl. CPC A01D 7/10

(57) ABSTRACT

A system and method for collecting and moving debris, including first and second handle extensions having first and second main shafts adapted to be secured to first and second tool shafts, respectively. Further, first and second under arm supports are mounted to an upper end of the first and second main shafts whereby a user places the first under arm support against their right underarm and second under arm support against their left underarm. Further, first and second handle grips mounted to the first main shaft and second main shafts for the user to hold in their right and left hands when collecting and moving the debris. It is also within the terms of the embodiment handle extension for exercising the knee and foot of one leg.

### FIELD OF THE INVENTION

The present invention relates to a tool handle system and more particularly to a system for collecting and moving debris, including handle extensions adapted to be connected to long handled tools.

### BACKGROUND OF THE INVENTION

Long handled tools, such as shovels, brooms, mops and gardening tools, are well known and have been used for centuries. Many people use long handled tools to move such things as piles of dirt, snow and debris. A typical example is the removal of debris such as cut grass and fallen leaves as an important part of lawn care. Gardening tools with long handles are well known and have been used for centuries, but the most ubiquitous tool for such debris removal is the rake. The leaf rake is an ancient, relatively simple gardening tool of which there are many varieties with significant differences. Gardeners and landscapers who wish to maintain a well-groomed lawn will regularly cut the grass and will use these standard, long handled hand tools to gather loose grass cuttings or clippings, fallen leaves, and other unattached relatively light lawn or yard debris. Although there are alternate and modern solutions to leaf raking and subsequent removal, including leaf blowers, bag-equipped power lawn mowers, or even burning in place, these are usually either noisy, comparatively expensive, unsafe, or environmentally suspect and thus the traditional, though laborious, lawn-raking task is still in wide use.

However, while the rake is adept at gathering fallen leaves and other debris into piles by raking, they are generally not designed for lifting capabilities. Once piled, one must transfer the leaves to a disposal or transport container, such as a trash bag or wheelbarrow, for transport to a dump or compost heap. Because of the necessary leverage for picking up and transporting the raked material, this task is usually the most difficult aspect of this activity. If the proper tools are unavailable, leaf and debris pick up may involve bending over, kneeling, or stooping, then gathering and pressing the leaves or other raked material with one hand, against the rake head and tines held by the other hand. This is not only fatiguing, but for people with back trouble, it can be difficult and painful.

### SUMMARY OF THE INVENTION

According to an embodiment of the present invention, there is disclosed a system for collecting and moving debris. The system includes first and second handle extensions having first and second main shafts adapted to be secured to first and second tool shafts, respectively. Further, the system includes first and second under arm supports mounted to an upper end of the first and second main shafts, respectively, the first and second under arm supports mounted to the upper end of the first and second main shafts disposed in first and second directions with respect to the first and second main shafts and whereby a user places the first under arm support against their right underarm and places the second under arm support against their left underarm. The system further includes first and second handle grips mounted to the first main shaft and second main shafts, respectively, and disposed in third and fourth generally opposite directions with respect to the first and second directions of the first and second arm supports, whereby the user grips the first handle grip with their right hand, and the second handle grip with their left hand so that a lower end of the first and second tool shafts can move towards or away from each other.

According to another embodiment of the present invention, there is disclosed a handle extension adapted to be secured to a tool shaft. The handle extension includes a main shaft having a lower section and an upper section, an under arm support mounted to an upper end of the upper section, a handle grip mounted between the lower section and the upper section of the main shaft, and means for securing the tool shaft to the main shaft.

According to another embodiment of the present invention, there is disclosed a handle extension for exercising the knee and foot of one leg. Two handle extensions can be used simultaneously to exercise the left and right legs. The handle extension includes a main shaft having a lower section and an upper section, an under arm support mounted to an upper end of the upper section, a handle grip mounted between the lower section and the upper section of the main shaft, and end cap, with eyebolt for securing a resistance band.

According to another embodiment of the present invention, there is disclosed a method for a user to collect and move debris. The method includes providing first and second handle extensions having first and second main shafts, first and second under arm supports mounted to an upper end of the first and second main shafts, and first and second handle grips mounted to the first main shaft and second main shafts. The method further includes first and second tool shafts having first and second rake heads mounted to the first and second handle extensions. The method further includes placing the first and second under arm supports against the users right and left underarms, respectively, and gripping the first and second handle grips with their right and left hands, respectively. The method further includes moving the first and second handle extensions whereby the first and second rake heads move towards each other to collect the debris therebetween, and moving the debris collected between the first and second rake heads.

### BRIEF DESCRIPTION OF THE DRAWINGS

The structure, operation, and advantages of the present invention will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a three-dimensional exploded view of the tool handle system, in accordance with the present invention.

FIG. 2 is a three-dimensional exploded view of a handle extension of the tool handle system, in accordance with the present invention.

FIG. 3 is a front three-dimensional view of a first position of the tool handle system in use, in accordance with the present invention.

FIG. 4 is a front three-dimensional view of a second position of the tool handle system in use, in accordance with the present invention.

FIG. 5 is a front three-dimensional view of an alternative embodiment of the tool handle system, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

Very often, cleanup tasks involve a need to gather debris into piles or bunches, which are subsequently picked up and disposed. In particular, rakes for collecting grass and leaves from a lawn are well known. For example, when gathering leaves that have accumulated in a yard, an individual will often gather the leaves into bunches, and then while bending over, may grasp the leaves by sandwiching them between a rear facing surface of the rake head and the user's hand/arm. Then, the user must lift the gathered leaves and debris and place them within a suitable container, involves the use of a second item or a hand/arm of the user. Such a process is slow, tedious, and can be quite arduous. The tool handle system 10 overcomes the shortcomings of earlier devices for collecting, picking up and carrying loose materials. The tool handle system 10 enables a user to both gather debris and comfortably lift the debris into a disposal container, without having to bend over.

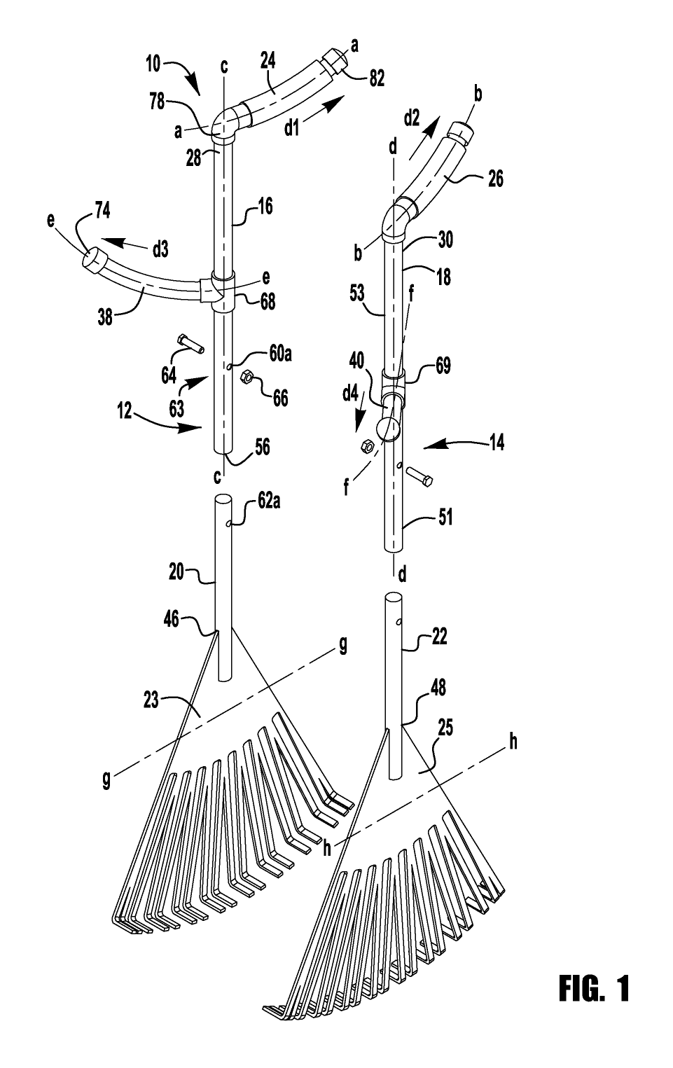

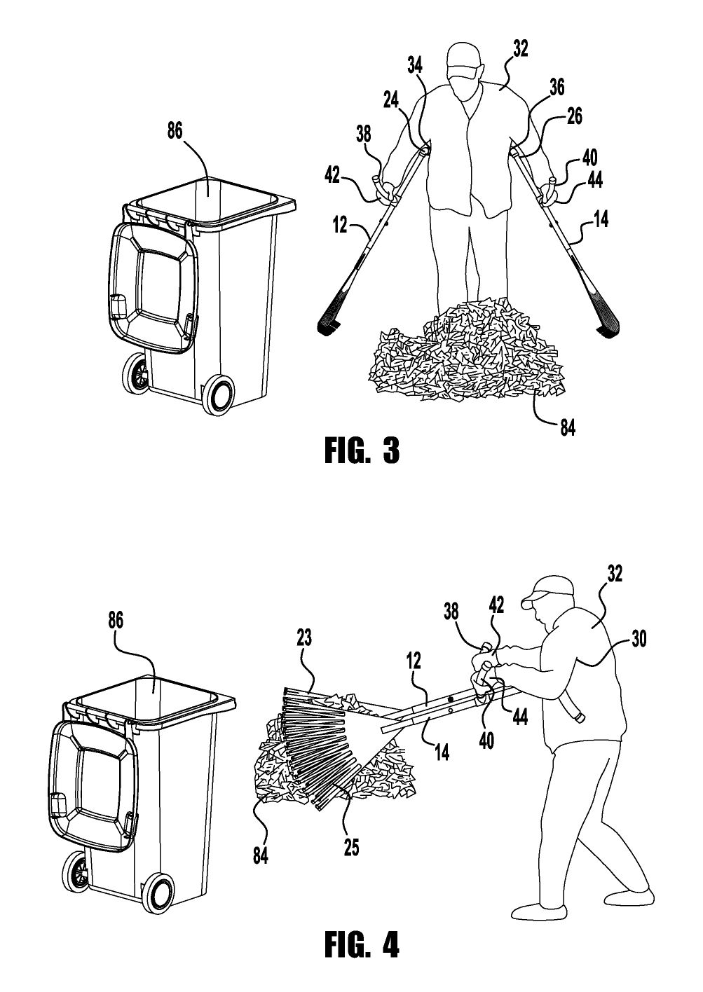

As seen in FIG. 1, the tool handle system 10 is a system for collecting and moving debris. In general terms, the system 10 includes first and second handle extensions 12 and 14, having first and second main shafts 16 and 18, adapted to be secured to first and second tool shafts 20 and 22, respectively. First and second under arm supports 24 and 26 are mounted to an upper end 28 and 30 of the first and second main shafts 16 and 18, respectively. The first under arm support 24 is disposed in a first direction d1 extending along the axis a-a through the arm support 24 and the second arm support 26 is disposed in a second direction d2 extending along the axis b-b through the arm support 26. The first and second arm supports 24 and 26 extend in the directions d1 and d2 with respect to the first and second main shafts 16 and 18, respectively, whereby a user 32 places the first under arm support 24 against their right underarm 34 and places the second under arm support 26 against their left underarm 36 (as seen in FIGS. 3 and 4). First and second handle grips 38 and 40 are mounted to the first main shaft and second main shafts 16 and 18, respectively. The first handle grip 38 is disposed in a third direction d3 extending along the axis e-e through the handle grip 38 and the second handle grip 40 is disposed in a fourth direction d4 extending along the axis f-f through the handle grip 40. The first and second handle grips 38 and 40 are disposed in third and fourth directions d3 and d4, respectively, generally in an opposite direction from the first and second directions d1 and d2 of the first and second arm supports 24 and 26, whereby the user 32 grips the first handle grip 38 with their right hand 42, and the second handle grip 40 with their left hand 44 after the first and second under arm supports 24 and 26 are positioned against the right and left underarms so that a lower end 46 and 48 of the first and second tool shafts 20 and 22 can move towards or away from each other. Further, the first under arm support 24 can rotate from its original first direction d1 between about 0° and 25° to the right or left of the centerline c-c of the first main shaft 16. The second under arm support 26 can rotate from its original second direction d2 between about 0° and 25° to the left or right of the centerline d-d of the second main shaft 18. In addition, the first handle grip 38 can rotate from its original third direction d3 between about 0° and 45° to the right or left of the centerline c-c of the first main shaft 16. The second handle grip 40 can rotate from its original fourth direction d4 between about 0° and 45° to the left or right of the centerline d-d of the second main shaft 18.

The first and second handle extensions 12 and 14 are designed to be utilized with first and second tool shafts 20 and 22 together, to collect and move debris, such as leaves. The tool shafts 20 and 22 may be connected to any desired tool, such as a mop, broom, first and second rake heads 23 and 25, respectively, or any other desired tool. First handle extension 12 is designed to be used with the right underarm 34 and right hand 42, and the second handle extension 14 is designed to be used with the left underarm 36 and left hand 44 of the user. However, it is within the terms of the embodiment that to use only one handle extension 12 in conjunction with a tool shaft 20 to move or collect debris. While the use of two tool shafts 20 and 22 connected to two tools is a preferred way of moving and collecting debris, the use of a single handle extension 12 combined with a tool shaft 20 is still an improvement on convention tools, since the handle extension provides an increased level of comfort and ease. Further, mounting a tool handle system 10 to a tool shaft creates a stronger tool shaft, especially at the highest pressure point then a standard tool shaft.

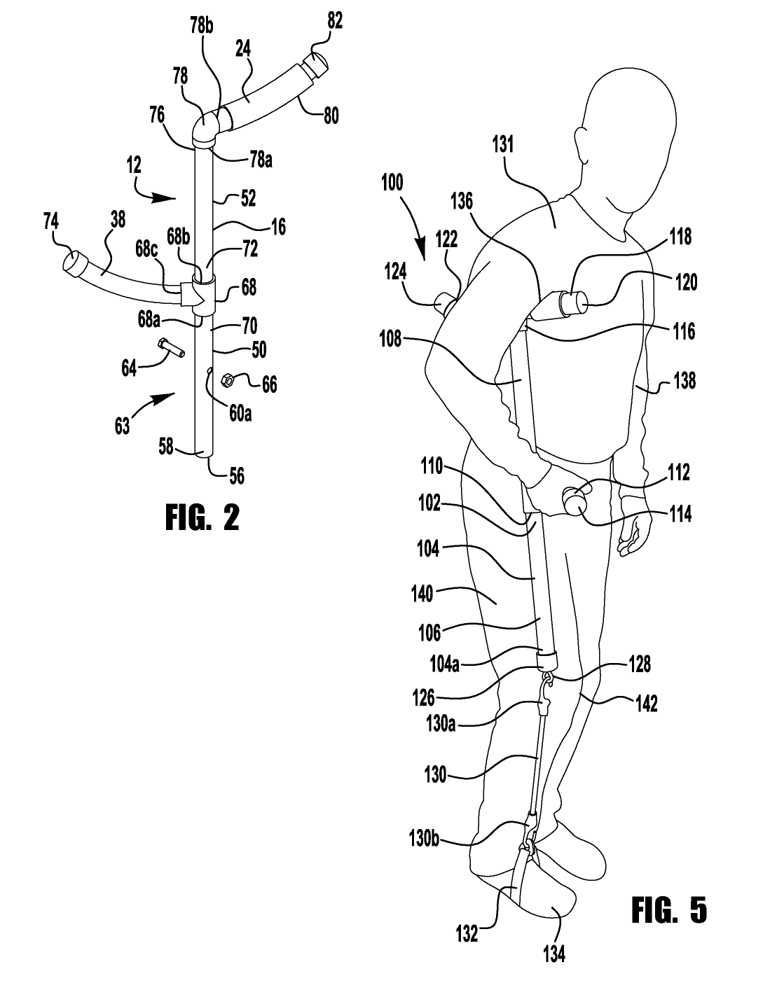

FIG. 2 illustrates a detailed view of the first handle extension 12. It is substantially identical to second handle extension 14, with the exception of the direction in which the first and second handle grips 38 and 40 extend. First handle grip 38 of the first handle extension 12, which is meant to be held with the right hand, extends in a direction generally opposite and slightly to the right of first arm support 24. The second handle grip 40 of the second handle extension 14 which is meant to be held with the left hand, extends in a direction generally opposite and slightly to the left of second arm support 26.

The first handle extension 12 may be constructed of any desirable material, preferably one that is lightweight, such as aluminum, stainless steel, plastic, polyvinyl chloride (pvc), fiberglass, carbon fiber or any combination of materials. The dimensions of the handle extension 12 may include any appropriate dimensions, such as an overall length of about 24 inches to about 38 inches and preferably about 34 inches, and a width from the free end of first arm support 24 to the free end of the first handle grip 38 of about 14 inches to about 19 inches and preferably about 17 inches.

First handle extension 12 includes a main shaft 16, having a lower section 50 and an upper section 52. An under arm support 24 is mounted to an upper end 28 of the upper section 52. A handle grip 38 is mounted between the lower section 50 and the upper section 52 of the main shaft 16. Means 63, such as for example a nut and bolt extending through a hole in the lower section 50 and the tool shaft 20, can be provided for removably securing the tool shaft 20 to the main shaft 16. However, it is within the terms of the embodiment that the tool shaft 20 is constructed with the handle extension 12 attached as part of the construction, such that it is not removably attached to the tool shaft. For example, the rake heads 23 and 25 may be permanently integrated into handle extensions 12 and 14. Further, each of the handle extensions 12 and 14 can be manufactured as one component, using any desired method, such as plastic injection molding.

The lower section 50 of the main shaft 16 is hollow to accommodate the tool shaft 20, and typically will have an outer diameter of about 1.125 to about 1.375 inches, and an inner diameter of about 0.875 to about 1.25 inches. However, the specific size can be adjusted for the particular too shaft and therefore any desired dimensions may be used. There is an opening 56 at a lower end 58 of the lower section 50 into which the tool shaft 20 is inserted. The means 63 for removably securing the tool shaft 20 to the main shaft 16 can include at least two parallel holes 60a and 60b (not shown) which are approximately 4 to about 8 inches from the first end 58. The holes 60a and 60b have any suitable diameter, typically between about 0.25 and about 0.3125 inches. As seen in FIG. 1, the aligned holes 60a and 60b correspond to a hole 62a extending through tool shaft 20, such that when the tool shaft is inserted within the lower section 50, the parallel holes 60a and 60b line up with hole 62a. Then, to secure the tool shaft 20, a bolt 64 extends through the parallel holes 60a and 60b and hole 62a, and is then secured with a nut 66. The length of the bolt 64 may be any appropriate length, such as between about 1.25 and 1.5 inches. It is within the terms of the embodiment that there be a plurality of vertically spaced holes can be provided through the lower section 50 to allow the tool handle system 10 to be adjustable for users of differing heights.

Means, such as a standard T-connector 68 is disposed between the lower section 50 and the upper section 52 of the main shaft 16. T-connector 68 has three openings 68a, 68b, and 68c, wherein the upper end 70 of lower section 50 extends into opening 68a, and a lower end 72 of upper section 52 extends into opening 68b. Hand grip 38, which may or may not be hollow, having a length of approximately 6-8 inches is mounted in opening 68c of T-connector 68. Hand grip 38 can be straight or have a curvature to 45 degrees. Attached to the end of hand grip 38 is end cap 74. The hand grip 38 will typically have an outer diameter of about 1.125 to about 1.375 inches, and an inner diameter of about 0.875 to about 1.25 inches. The T-connector 68 is attached between the lower section 50 and the upper section 52 so that the centerline e-e is at an angle between 0° and 45° relative to a centerline g-g through the tool, i.e., the rake head 23, secured to the tool shaft 20. The T-connector 68 will have dimensions suitable to accommodate the lower section 50 and the upper section 52, such as an outer diameter of about 1.25 to about 1.75 inches, and an inner diameter of about 1.00 and about 1.375 inches.

As with the first handle extension 12, second handle extension 14 includes means, such as a standard T-connector 69, disposed between the lower section 51 and the upper section 53 of the main shaft 18. T-connector 69 has three openings into which the upper section 53, the lower section 51 and the second handle grip 40 are mounted. Further, the handle grip 40 can be rotated about axis d-d of the second main shaft 18 with respect to a centerline h-h through the tool, i.e., the rake head 25, secured to the tool shaft 22.

The openings 68a, 68b, and 68c of the T-connector 68 can be permanently secured to lower section 50, upper section 52, and handle grip 38 or tightly mounted so that the lower section 50, upper section 52, and handle grip 38 can be adjusted with respect to each other so that the handle extension 12 can be adjusted to fit the particular user.

The upper section 52 of the main shaft 16, may or may not be hollow, and typically will have an outer diameter of about 1.125 to about 1.375 inches, and an inner diameter of about 0.875 to about 1.25 inches. However, the upper section 52 may be constructed with any desired dimensions. A substantially 90° elbow 78, with an inner diameter of about 1.0 to about 1.375 inches and outer diameter of about 1.25 to about 1.75 inches, is attached to the upper section 52. Elbow 78 has two openings 78a and 78b, and an upper end 76 of the upper section 52 extends into opening 78a and the under arm support 24 which extends into opening 78b. Preferably, the under arm support 24 will have a length of approximately about 6 to about 8 inches, and typically will have an outer diameter of about 1.125 to about 1.375 inches, and an inner diameter of about 0.875 to about 1.25 inches. Under arm support 24 may or may not be hollow. Under arm support 24 can be straight, or have a slight upward curvature to 45°. The arm support 24 is attached to the main shaft 16 so that the centerline a-a is at an angle between 0° and 45° relative to a centerline g-g through the tool, i.e., the rake head 23, secured to the tool shaft 20. Preferably, a piece of padding 80, constructed of rubber or foam, will cover the under arm support 24. Attached to the end of the under arm support 24 is an end cap 82, which has an inner diameter of about 1.0 inches to about 1.375 inches and outer diameter of about 1.25 to about 1.75 inches.

As seen in FIGS. 3 and 4, the tool handle system 10 includes a method for a user 32 to collect and move debris 84. The method includes providing first and second handle extensions 12 and 14 having first and second main shafts 16 and 18, first and second under arm supports 24 and 26 mounted to an upper end 28 and 30 of the first and second main shafts, and first and second handle grips 38 and 40 mounted to the first main shaft and second main shafts. The method also includes securing the first and second handle extensions 12 and 14 to first and second tool shafts 20 and 22 having first and second rake heads 23 and 25, respectively.

Then, the method includes placing the first and second under arm supports 24 and 26 against their right and left underarms 34 and 36, respectively, and gripping the first and second handle grips 38 and 40 with their right and left hands 42 and 44, respectively. Then, moving the first and second handle extensions 12 and 14 whereby the first and second rake heads 23 and 25 move towards each other to collect the debris 84 therebetween, and then move the debris collected between the first and second rake heads, as seen in FIG. 4.

After the debris 84 has been collected, it may be placed within a collection container 86 by placing the debris over the collection container and reducing pressure on the first and second handle extensions 12 and 14 and moving the handle extensions outward and apart from one another.

The user 32 may position the first and second handle extensions 12 and 14 to accommodate their particular needs. The user 32 may position first and second handle grips 38 and 40 to a suitable location with respect to their right and left hands 42 and 44, respectively, based on whatever angle and position is desired. Similarly, user 32 may position first and second under arm supports 24 and 26 to a suitable location with respect against their right and left underarms 34 and 36 to whatever angle and position is desired.

FIG. 5 illustrates an alternative embodiment of the tool handle system 100, includes first and second handle extensions, although only first handle extension 102 is illustrated. However, first handle extension 102 is substantially identical to the second handle extension (not shown). First handle extension 102 has a main shaft 104, having a lower section 106 and an upper section 108.

A standard T-connector 110 is between the lower section 106 and the upper section 108, that joins these two sections. The T-connector 110 will have dimensions suitable to accommodate the lower section 106 and the upper section 108, such as an outer diameter of about 1.25 to about 1.75 inches, and an inner diameter of about 1.0 to about 1.375 inches.

Further attached to the T-connector 110 is the handle grip 112. Preferably, the handle grip 38 will have a length of about 6 to about 8 inches, and typically will have an outer diameter of about 1.125 to about 1.375 inches, and an inner diameter of about 0.875 to about 1.25 inches. Handle grip 112 may be straight, or have a curvature to approximately 45°. Attached to the end of the handle grip 112 is an end cap 114, which has an inner diameter of about 1.0 to about 1.375 inches and outer diameter of about 1.25 to about 1.75 inches. Handle grip 112 extends in a direction generally opposite and slightly to the right of arm support 122.

Attached to the upper section 108 can be a standard T-connector 116 with the same specifications as the T-connector 110. Attached to one side of the T-connector 116 is the front upper under arm support 118, which is a straight section of pipe having a length of about 4 to about 6 inches and having an end cap 120. Attached to the opposite side of the T-connector 116 is the rear upper under arm support 122, which is a straight section of pipe having a length of about 4 to about 6 inches and having an end cap 124. The rear upper under arm support 122 can be straight, or with a concave curve to be comfortably disposed against the underarm of the user 131. The front and rear upper supports 118 and 122 may be covered entirely with a piece of padding made of rubber or foam.

End cap 126 is mounted to the bottom end 104a of the lower section 106. Inserted through the center of the end cap 126 is an eye bolt 128, having a diameter of about 0.25 to about 0.3125 inches. The eye bolt 128 is secured to the end cap with a hex head nut (not shown) or any other desired means of attachment. A resistance band 130 is to be connected to eye bolt 128.

In use, the user 131 attaches one end 130a of a resistance band 130 having a specific “pounds of pull” resistance to the eye bolt 128 on the handle extension 102. The user attaches a foot strap 132 to the opposite end 130b of the resistance band 130, and places the band around their foot 134. The user 131 can perform the same steps for the opposite side and foot (not shown). While keeping their feet in the foot straps 132, the user 131 stands. The user 131 places either the front or rear upper supports 118 or 122 under his arm 136, and does the same with his other arm, and grips and pulls up on the handle grip 112. As the user 131 makes the motion of bending the leg 140 at the knee 142 and lifting the foot 134 forward. Then, the user 131 lowers the handle extension 102 and begins to pull up on the opposite handle grip of the other handle extension (not shown). This movement is useful for leg and foot therapy. As the user's legs get stronger, the resistance bands can be made heavier or lighter.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A system for collecting and moving debris, comprising:
first and second handle extensions having first and second main shafts adapted to be secured to first and second tool shafts, respectively;
first and second under arm supports mounted to an upper end of the first and second main shafts, respectively, the first and second under arm supports mounted to the upper end of the first and second main shafts disposed in first and second directions with respect to the first and second main shafts and whereby a user places the first under arm support against their right underarm and places the second under arm support against their left underarm; and
first and second handle grips mounted to the first main shaft and second main shafts, respectively, and disposed in third and fourth generally opposite directions with respect to the first and second directions of the first and second arm supports, whereby the user grips the first handle grip with their right hand, and the second handle grip with their left hand so that a lower end of the first and second tool shafts can move towards or away from each other.

2. The system of claim 1 wherein the first and second main shafts are removably connected to the first and second tool shafts, respectively.

3. The system of claim 2 wherein a first and second lower section of the first and second main shafts, respectively will be hollow to accommodate the first and second tool shafts.

4. The system of claim 2 wherein a first and second T-connector is between first and second lower sections and first and second upper sections of the first and second main shafts, respectively.

5. The system of claim 2 wherein the first under arm support can rotate about an axis through the first main shaft from its original first direction between about 0° and 25° to the right of the first main shaft, and the second under arm support can rotate about an axis through the second main shaft from its original second direction between about 0° and 25° to the left of the second main shaft.

6. The system of claim 2 wherein the first handle grip can rotate about an axis through the first main shaft from its original third direction between about 0° and 45° to the right of the first main shaft, and the second handle grip can rotate about an axis through the second main shaft from its original fourth direction between 0° and 45° to the left of the second main shaft.

7. The system of claim 4 wherein the first and second lower sections and first and second upper sections of the first and second main shafts are mounted to be able to rotate between 0° and 25° about an axis through the first and second main shafts, respectively.

8. A handle extension adapted to be secured to a tool shaft, comprising:
a main shaft having a lower section and an upper section;
an under arm support mounted to an upper end of the upper section;
a handle grip mounted between the lower section and the upper section of the main shaft; and
means for securing the tool shaft to the main shaft.

9. The handle extension of claim 8 wherein the main shaft will be removably connected to the tool shaft.

10. The handle extension of claim 9 wherein the lower section of the main shaft is hollow to receive the tool shaft.

11. The handle extension of claim 10 wherein a T-connector is between the lower section and the upper section of the main shaft.

12. The handle extension of claim 8 wherein the under arm support can rotate with respect to a centerline through the main shaft from its original first direction to between about 0° and 25° to the right or left of the main shaft.

13. The handle extension of claim 8 wherein the handle grip can rotate with respect to a centerline through the main shaft from its original third direction to between about 0° and 45° to the right or left of the first main shaft.

14. The handle extension of claim 10 wherein the lower section and the upper section of the main shaft are mounted to be able to rotate between about 0° and 25° within the T-connector.

15. The handle extension of claim 8 wherein a piece of padding, constructed of rubber or foam, covers the under arm support.

16. The handle extension of claim 8 wherein an end cap is attached to the end of the handle grip.

17. A method for a user to collect and move debris, comprising:
providing first and second handle extensions having first and second main shafts, first and second under arm supports mounted to an upper end of the first and second main shafts, and first and second handle grips mounted to the first main shaft and second main shafts;
providing first and second tool shafts having first and second rake heads secured to the first and second handle extensions to, respectively;
placing the first and second under arm supports against the user's right and left underarms, respectively;
gripping the first and second handle grips with the user's right and left hands, respectively;
moving the first and second handle extensions whereby the first and second rake heads move towards each other to collect the debris therebetween; and
moving the debris collected between the first and second rake heads.

18. The method of claim 17 further including positioning the first and second handle extensions whereby the first and second under supports are comfortably disposed against the user's right and left underarms, and the first and second handle grips are comfortably disposed in the user's right and left hands.

19. The method of claim 18 further including positioning the first and second under arm supports to a suitable location with respect against the user's right and left underarms, respectively.

20. The method of claim 19 further including positioning of first and second handle grips to a suitable location with respect to the user's right and left hands, respectively.
